(19) United States
(12) Patent Application Publication
(10) Pub. No.: US 2026/0066955 A1
(43) Pub. Date: Mar. 5, 2026

(54) 5G OVER COAXIAL ENABLED SMALL CELL SYSTEMS AND METHODS

(71) Applicant: CHARTER COMMUNICATIONS OPERATING, LLC, St. Louis, MO (US)

(72) Inventors: Ramneek BALI, Aurora, CO (US); Manish JINDAL, Lone Tree, CO (US); Gary KOERPER, Castle Pines, CO (US)

(73) Assignee: CHARTER COMMUNICATIONS OPERATING, LLC, St. Louis, MO (US)

(21) Appl. No.: 18/818,514

(22) Filed: Aug. 28, 2024

(51) Int. Cl. H04B 7/0413; H04L 12/28

(52) U.S. Cl. CPC H04B 7/0413; H04L 12/2801

(57) ABSTRACT

Apparatus and methods are disclosed. The small cell apparatus includes a port to interface with a coaxial cable, the coaxial cable configured to transmit a signal from a radio unit (RU); an impedance matching component configured to sufficiently match the signal; a diplexer configured to separate the signal into a separated signal; a signal converter configured to increase and/or decrease the separated signal to an emission signal at an emission frequency; a transceiver node configured to map the emission signal to two or more multiple-input multiple-output (MIMO) layers; and an antenna configured to transmit the two or more MIMO layers.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates generally to the field of data networks and wireless devices, and specifically to an architecture which provides high-speed data service in a content delivery network.

### BACKGROUND

Data communication services are now ubiquitous throughout user premises (e.g., home, office, vehicles, and even larger venues such as e.g., sports arenas, conference or convention centers, hotels, concert halls, airports, etc.). Such data communication services may be provided via a managed or unmanaged network. For instance, a typical home has services provided by one or more network service providers via a managed network such as a cable or satellite network. These services may include content delivery (e.g., linear television, on-demand content, personal or cloud DVR, “start over”, etc.), as well as so-called “over the top” delivery of third-party content. Similarly, Internet and telephony access is also typically provided, and may be bundled with the aforementioned content delivery functions into subscription packages, which are increasingly becoming more user- or premises-specific in their construction and content. Such services are also increasingly attempting to adopt the paradigm of “anywhere, anytime”, so that users (subscribers) can access the desired services (e.g., watching a movie) via several different receiving and rendering platforms, such as in different rooms of their houses, or on their mobile devices while traveling, etc.

Issues with Existing Architecture and Services

As user appetite for enhanced data rates, mobility and diversity of services has increased over time, service providers have sought new technologies and paradigms for service delivery to meet those needs. In the case of cable networks, there may be limits to the expansion or enhancement of services under traditional technology models (e.g., use of 800 MHz of spectral bandwidth with limited upstream bandwidth, modulation schemes, DOCSIS protocols, etc.) Indeed, even where such enhancements are possible, significant capital and R&D (research and development) expenditures are required to upgrade or adapt existing technologies and infrastructure to the new levels of performance.

As an example of the foregoing, consider a multi-dwelling unit (MDU) served by an existing hybrid fiber coax (HFC) network topology (see discussion of FIGS. 2 and 3 below). The network will typically utilize optical fiber (and/or coaxial cable) to deliver data to a network node, which then converts the optical domain data to RF (radio frequency) signals for transmission over the existing coaxial cable distribution network and to the served customers at the edge of the network (including the aforementioned MDU, which is likely internally wired with coaxial cable serving each individual dwelling unit therein, with the owner of the MDU retaining ownership of the cable installed by the multiple systems operator (MSO) and hence representing a “sunk cost” investment to the MSO). As customers demand increased levels of service (high data rates, more features, etc.) the cable MSO is often required to upgrade the infrastructure serving such MDUs, including the addition of fixed wireless access (FWA) infrastructure, replacing coaxial cable with optical fiber, and other modifications.

For instance, to achieve certain capacity targets (e.g., 10 Gbps) over such infrastructure, optical fiber is needed. Under current HFC network design, services are provided to users via a coaxial cable “drop” to their premises, and groups of such premises are served by common tap-off points or nodes within the larger architecture (see discussion of cable systems supra). Individual premises “tap off” the cabling or other infrastructure from each node and, depending on their geographic placement and other considerations, may require the utilization of different amplification units to maintain sufficient signal strength to reach the most distant (topology-wise) premises in the system. For instance, a common description of how many amplifier stages can be used between a source node and premises is “N+i”, where i=the number of amplifier stages between the source node and the premises. For instance, N=0 refers to the situation where no amplifiers are used, and N+3 refers to use of three (3) amplifiers. In some extant cable/HFC systems in operation, values of i may be as high as seven (7); i.e., N+7, such as for service to rural areas.

Use of such amplifier stages introduces some limitations on the data rates or bandwidth (both downstream—i.e., toward the client premises; and upstream—i.e., from the client premises) achievable by such systems. In effect, such systems are limited in maximum bandwidth/data rate, due in part to the design of the amplifiers; for example, they are typically designed to provide services primarily in the downstream direction (with much lower upstream bandwidth via so-called “OOB” or out-of-band RF channels providing highly limited upstream communication).

Cable modem or DOCSIS-compliant systems utilize DOCSIS QAMs (RF channels) for enhanced upstream bandwidth capability such as for Internet services, but even such technologies are limited in capability, and may have limited flexibility in the allocation of downstream versus upstream bandwidth. For example, based on the DOCSIS protocols utilized for e.g., a coaxial infrastructure available in the aforementioned MDU served within a managed HFC network, throughput availability for downstream and upstream is in effect “hard-wired” based on how much of an available amount of spectrum is reserved for each direction. Because of this hard-wired availability, as well as the use of the aforementioned taps and amplifier stages, upstream throughput is limited in the foregoing HFC network.

One way of potentially achieving higher data rates could be replacement of such amplifier stages (and supporting coaxial cabling) with other mediums such as optical fiber (sometimes referred to as going “fiber deep”, which can provide for example higher bandwidth, lower loss, and symmetric operation), microwave dishes at rooftop, and Ethernet cable (which can also provide symmetric operation), including going all the way back to an N+0 configuration throughout the entire network. However, replacement of literally tens of thousands of amplifiers and thousands of miles of cabling with optical fiber or the like is prohibitively expensive, and can take years.

Another potential way to achieve higher data rates may be achieved by implementation of DOCSIS 4.0 protocols; this version of the DOCSIS standard supports e.g., two (2) modes of use: (i) extended spectrum, without full duplex (which means separate allocation of downstream and upstream bandwidth, which can result in loss of capacity since the downstream and upstream bandwidth needs may not necessarily be static); and (ii) full duplex. Full duplex or symmetric DOCSIS 4.0, while providing significant enhancement over existing asymmetric DOCSIS systems, similarly requires significant capital investment and technology development, including relating to its supporting ecosystem (which in fact is one salient reason why the 4.0 standard also includes the first (i) mode described above, which in effect amounts to a legacy mode). The high implementation cost (including a long lead time) of continuous research and development for the newer developments in DOCSIS is moreover likely to persist, in part due to fragmented MSO selection of one of the aforementioned modes over the other.

Thus, replacing large portions of coaxial cable infrastructure with optical fiber, retrofitting to utilize the latest DOCSIS 4.0 technology, adding FWA for high-speed wireless backhaul, or other such upgrades to the existing MSO infrastructure represent (i) a huge CAPEX cost for the MSO (especially in dense urban environments with literally hundreds of closely spaced MDUs), and (ii) in some cases significant amounts of R&D for development of the necessary supporting ecosystem; these expenditures and development-induced latencies ideally would be at least partly avoided if somehow the extant HFC infrastructure could be enhanced or “repurposed” to include higher data rates, more symmetry between US and DS capability, and expanded types of services (such as mobility services).

Additionally, another issue to be addressed is the presence of delivered versus actual capacity “mismatch” with current systems. Even with delivery systems that currently provide a high degree of capability and symmetry (such as optical fiber), extant technologies for utilizing this delivered capacity symmetrically, and to its full capacity, are only now under development and not yet deployed. As such, even with a high US and DS capability available with e.g., optical fiber service, the end-user equipment such as 802.11ac routers can only utilize portions of this capability (and not nearly to its full capacity). Similarly, when considering a coaxial cable, it in theory can provide much higher data rates, and symmetrically, than current delivery paradigms such as DOCSIS 3.1 used by cable modems, and in-band 6 MHz channels (DS) used by DTSBs can provide. Hence, stated simply, the large existing inventory of coaxial cable is physically capable of much better performance than current protocols and end-user components can support.

Accordingly, improved node apparatus and methods of placement and operation thereof are needed to, inter alia, enable optimized delivery of ultra-high data rate services (both wired and wireless) symmetrically, and which leverage extant network infrastructure such as the large inventory of installed coaxial cable and supporting infrastructure in both MSO networks and the premises they serve. Such improved node apparatus and methods would also enable various network architectures that can be utilized to provide high-capacity data services to a plurality of user premises and venues under varying different configurations.

Embodiments of the present disclosure also provide related systems, methods, and/or program products.

### BRIEF SUMMARY OF THE DISCLOSURE

In accordance with one or more embodiments, apparatus and methods are disclosed.

The small cell apparatus includes a port to interface with a coaxial cable, the coaxial cable configured to transmit a signal from a radio unit (RU); an impedance matching component configured to sufficiently match the signal; a diplexer configured to separate the signal into a separated signal; a signal converter configured to increase and/or decrease the separated signal to an emission signal at an emission frequency; a transceiver node configured to map the emission signal to two or more multiple-input multiple-output (MIMO) layers; and an antenna configured to transmit the two or more MIMO layers.

These and other advantages of the disclosure will be apparent to those of ordinary skill in the art by reference to the following detailed description and the accompanying drawings.

### BRIEF DESCRIPTION OF THE DRAWINGS

The accompanying drawings, which are incorporated in and constitute a part of this specification, illustrate embodiments of the disclosure, and, together with the summary given above, and the detailed description of the embodiments below, serve as a further explanation and disclosure to explain or illustrate embodiments of the disclosure. The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating a typical prior art managed (e.g., HFC cable) content delivery network architecture.

FIG. 3 is a functional block diagram illustrating a typical prior art managed (e.g., HFC cable) content delivery network architecture.

FIG. 4 is a graphical representation of an exemplary frequency band functional assignment according to an embodiment of the present disclosure.

FIG. 5 is a graphical representation of another exemplary frequency band functional assignment according to an embodiment of the present disclosure.

FIG. 6 is a graphical representation of yet another exemplary frequency band functional assignment according to an embodiment of the present disclosure.

FIG. 7 depicts a block diagram of a network architecture benefiting from the various embodiments.

FIG. 8 depicts a block diagram of a small cell repeater.

FIG. 9 depicts a block diagram of a network architecture for a plurality of small cell repeaters.

All Figures© Copyright 2024 Charter Communications Operating, LLC. All rights reserved.

### DETAILED DESCRIPTION

To facilitate the understanding of this disclosure a number of terms in quotation marks are defined below. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that various embodiments of the present application may be practiced without these specific details. In other instances, well-known structures or processing steps have not been described in detail in order to avoid obscuring the present application.

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when element is referred to as being “beneath” or “under” another element, it can be directly beneath or under the other element, or intervening elements may be present. In contrast, when an element is referred to as being “directly beneath” or “directly under” another element, there are no intervening elements present.

As used herein, the term “substantially” or “substantial”, is equally applicable when used in a negative connotation to refer to the complete or near complete lack of an action, characteristic, property, state, structure, item, or result. For example, a surface that is “substantially” flat would either be completely at, or so nearly flat that the effect would be the same as if it were completely flat.

As used herein, terms defined in the singular are intended to include those terms defined in the plural and vice versa.

As used in this specification and its appended claims, terms such as “a”, “an” and “the” are not intended to refer to only a singular entity but include the general class of which a specific example may be used for illustration, unless the context dictates otherwise. The terminology herein is used to describe specific embodiments of the disclosure, but their usage does not delimit the disclosure, except as outlined in the claims.

Unless otherwise indicated, all numbers expressing quantities of ingredients, properties such as molecular weights, reaction conditions, and so forth as used in the specification and claims are to be understood as being modified in all instances by the term “about.” Accordingly, unless indicated to the contrary, the numerical parameters in the specification and claims are approximations that may vary depending upon the desired properties sought to be obtained by the present disclosure. At the very least, and without limiting the application of the doctrine of equivalents to the scope of the claims, each numerical parameter should at least be construed in light of the number of reported significant digits and by applying ordinary rounding techniques. Notwithstanding that the numerical ranges and parameters describing the broad scope of the disclosure are approximations, the numerical values in the specific examples are reported as precisely as possible. Any numerical value, however, inherently contains standard deviations that necessarily result from the errors found in the numerical value's testing measurements.

Thus, reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc. In yet another illustration, reference herein to a range of from “5 to 10” includes whole numbers of 5, 6, 7, 8, 9, and 10, and fractional numbers 5.1, 5.2, 5.3, 5,4, 5,5, 5.6, 5.7, 5.8, 5.9, etc.

In the discussion and claims herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10%, or any point therein.

As used herein, the term “access node” refers generally and without limitation to a network node which enables communication between a user or client device and another entity within a network, such as for example a CBRS, CBSD, a cellular xNB, a Wi-Fi AP, or a Wi-Fi-Direct enabled client or other device acting as a Group Owner (GO).

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the term “CBRS” refers without limitation to the CBRS architecture and protocols described in Signaling Protocols and Procedures for Citizens Broadband Radio Service (CBRS): Spectrum Access System (SAS)—Citizens Broadband Radio Service Device (CBSD) Interface Technical Specification—Document WINNF-TS-0016, Version V1.2.1.3, January 2018, incorporated herein by reference in its entirety, and any related documents or subsequent versions thereof.

As used herein, the terms “client device” or “user device” or “UE” include, but are not limited to, set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “DOCSIS” refers to any of the existing or planned variants of the Data Over Cable Services Interface Specification, including for example DOCSIS versions 1.0, 1.1, 2.0, 3.0, 3.1 and 4.0 and any EuroDOCSIS counterparts or derivatives relating thereto, as well as so-called “Extended Spectrum DOCSIS”.

As used herein, the term “headend” or “backend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, over-the-top services, streaming services, and the Internet.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), and 4G/4.5G LTE.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the terms “MSO” or “multiple systems operator” refer to a cable, satellite, or terrestrial network provider having infrastructure required to deliver services including programming and data over those mediums.

As used herein, the terms “MNO” or “mobile network operator” refer to a cellular, satellite phone, WMAN (e.g., 802.16), or other network service provider having infrastructure required to deliver services including without limitation voice and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANS, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, LTE/LTE-A/LTEU/LTE-LAA, 5G NR, WAP, SIP, UDP, FTP, RTP/RTCP, H.323, etc.).

As used herein, the term “network interface” refers to any signal or data interface with a component or network including, without limitation, those of the Fire Wire (e.g., FW400, FW800, etc.), USB (e.g., USB 2.0, 3.0. OTG), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), LTE/LTE-A/LTE-U/LTE-LAA, Wi-Fi (802.11), WiMAX (802.16), Z-wave, PAN (e.g., 802.15), or power line carrier (PLC) families.

As used herein the terms “5G” and “New Radio” or “NR” refer without limitation to apparatus, methods or systems compliant with 3GPP Releases 15-19, and any modifications, subsequent Releases, or amendments or supplements thereto which are directed to New Radio technology, whether licensed or unlicensed. NG-RAN or “NextGen RAN (Radio Area Network)” is part of the 3GPP “5G” next generation radio system. 3GPP specifies its components, and interactions among the involved nodes including so-called “gNBs” (next generation Node B's or cNBs). NG-RAN will provide very high-bandwidth, very low-latency (e.g., on the order of 1 ms or less “round trip”) wireless communication and efficiently utilize, depending on application, both licensed and unlicensed spectrum of the type described supra in a wide variety of deployment scenarios, including indoor “spot” use, urban “macro” (large cell) coverage, rural coverage, use in vehicles, and “smart” grids and structures. NG-RAN will also integrate with 4G/4.5G systems and infrastructure, and moreover new LTE entities are used (e.g., an “evolved” LTE eNB or “eLTE eNB” which supports connectivity to both the EPC (Evolved Packet Core) and the NR “NGC” (Next Generation Core).

In some aspects, exemplary Release 15 NG-RAN leverages technology and functions of extant LTE/LTE-A technologies (colloquially referred to as 4G or 4.5G), as bases for further functional development and capabilities. For instance, in an LTE-based network, upon startup, an eNB (base station) establishes S1-AP connections towards the MME (mobility management entity) whose commands the eNB is expected to execute. An eNB can be responsible for multiple cells (in other words, multiple Tracking Area Codes corresponding to E-UTRAN Cell Global Identifiers). The procedure used by the eNB to establish the aforementioned S1-AP connection, together with the activation of cells that the eNB supports, is referred to as the S1 SETUP procedure; see inter alia, 3GPP TS 36.413 V14.4. entitled “3rd Generation Partnership Project; Technical Specification Group Radio Access Network; Evolved Universal Terrestrial Radio Access Network (E-UTRAN); S1 Application Protocol (SIAP) (Release 14)” dated September 2017, which is incorporated herein by reference in its entirety.

As used herein, the term “QAM” refers to modulation schemes used for sending signals over e.g., cable or other networks. Such modulation scheme might use any constellation level (e.g. QPSK, 16-QAM, 64-QAM, 256-QAM, etc.) depending on details of a network. A QAM may also refer to a physical channel modulated according to the schemes.

As used herein, the term “SAS (Spectrum Access System)” refers without limitation to one or more SAS entities which may be compliant with FCC Part 96 rules and certified for such purpose, including (i) Federal SAS (FSAS), (ii) Commercial SAS (e.g., those operated by private companies or entities), and (iii) other forms of SAS.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “users” may include without limitation end users (e.g., individuals, whether subscribers of the MSO network, the MNO network, or other), the receiving and distribution equipment or infrastructure such as a FWA/CPE or CBSD, venue operators, third party service providers, or even entities within the MSO itself (e.g., a particular department, system or processing entity).

As used herein, the term “Wi-Fi” refers to, without limitation and as applicable, any of the variants of IEEE Std. 802.11 or related standards including 802.11 a/b/g/n/s/v/ac/ad/ax/ba or 802.11-2012/2013, 802.11-2016, as well as Wi-Fi Direct (including inter alia, the “Wi-Fi Peer-to-Peer (P2P) Specification”, incorporated herein by reference in its entirety).

As used herein, the term “wireless” means any wireless signal, data, communication, or other interface including without limitation Wi-Fi, Bluetooth/BLE, 3GPP/3GPP2, HSDPA/HSUPA, TDMA, CBRS, CDMA (e.g., IS-95A, WCDMA, etc.), FHSS, DSSS, GSM, PAN/802.15, WiMAX (802.16), 802.20, Zigbee®, Z-wave, narrowband/FDMA, OFDM, PCS/DCS, LTE/LTE-A/LTE-U/LTE-LAA, 5G NR, LoRa, IoT-NB, SigFox, analog cellular, CDPD, satellite systems, millimeter wave or microwave systems, acoustic, and infrared (i.e., IrDA).As used herein, the term “xNB” refers to any 3GPP-compliant node including without limitation eNBs (eUTRAN) and gNBs (5G NR).

As used herein, the term “central unit” or “CU” refers without limitation to a centralized logical node within a network infrastructure. For example, a CU might be embodied as a 5G/NR gNB Central Unit (gNB-CU), which is a logical node hosting RRC, SDAP and PDCP protocols of the gNB or RRC and PDCP protocols of the en-gNB that controls the operation of one or more gNB-DUs, and which terminates the F1 interface connected with one or more DUs (e.g., gNB-DUs) defined herein.

As used herein, the term “distributed unit” or “DU” refers without limitation to a distributed logical node within a network infrastructure. For example, a DU might be embodied as a 5G/NR gNB Distributed Unit (gNB-DU), which is a logical node hosting RLC, MAC and PHY layers of the gNB or en-gNB, and its operation is partly controlled by gNB-CU (referenced herein). One gNB-DU supports one or multiple cells. The gNB-DU terminates the F1 interface connected with the gNB-CU.

As used herein, the term “radio unit” or “RU” refers to a unit or node capable of the transceiver functionality of the network device for transmitting and/or receiving radio signals. Examples of the RU include a Remote Radio Module (RRU), a radio header (RH), a remote radio head (RRH), a Low Power Remote Radio Head (LP-RRH). Management functions of the RU may be controlled by a CU.

In a disaggregated RAN (Radio Access Network) with a PHY functional split as espoused by the Open Radio Access Network (O-RAN) Alliance, the PHY functions may be split between the RU (Radio Unit) and the distributed or digital unit (DU). Protocol layers above the PHY (e.g., MAC, RLC, PDCP, SDAP) may be located at the central unit (CU). The RU-DU transport link is known as fronthaul and CU-DU transport link is known as midhaul. CPRI or eCPRI is typically used as the mid-haul and fronthaul transport protocol. An RU that conforms to the O-RAN PHY functional split architecture is referred to as an O-RU.

O-RAN), which is an open network standard applicable to a 5th generation (5G) system. The O-RAN has newly defined the legacy 3GPP network elements (NEs), an RU, a DU, a central unit-control plane (CU-CP)), a central unit-user plane (CU-UP) as an open RU (O-RU), an open DU (O-DU), an open CU-CP (O-CU-CP), and an open CU-CP (O-CU-UP), respectively (which may be collectively referred to as an O-RAN BS), and has additionally proposed a RAN intelligent controller (RIC) and a non-real-time RAN intelligent controller (NRT-RIC).

In one exemplary aspect, the present disclosure provides improved network architectures, and node apparatus and associated methods for providing enhanced ultra-high data rate services which, inter alia, leverage existing managed network (e.g., cable network/HFC) infrastructure. Advantageously, the disclosed architectural components (nodes, amplifiers, cores, taps and counterpart CPE) can be utilized in a variety of topologies, with network nodes disposed so as to support multiple downstream CPE including e.g., wherever an optical waveform is to be converted to a signal to be transmitted via coaxial cable. For instance, in one configuration, a node may be used further back towards the service provider core, such as to support a number of individual customer premises (e.g., homes) served by coaxial cable infrastructure. In another configuration, the node may be used at the very edge of the network to service a number of customers within a residential multi-dwelling unit or MDU (e.g., apartment building or condominium complex), that is wired with coaxial cable yet served by a proximate fiber drop (e.g., FTTC).

Further, other exemplary configurations can support various types of use cases (including premises-specific ones) such as e.g., providing an outdoor small cell service, a distributed antenna system (DAS) for an enterprise or other such premises, a venue-specific DAS, and additional reliability through redundancy. Numerous other configurations are possible when utilizing the adaptable and application-specific configurability of the methods and apparatus described herein.

As used herein, the term “small cell” refers to a range of low-powered radio access nodes, including microcells, picocells, and femtocells, that operate in both licensed and unlicensed spectrum with a smaller range than that of a “macrocell.” It will be recognized that, while techniques disclosed herein are primarily described with reference to small cells, the techniques may be broadly applicable to other types and sizes of radios, including, for example, macrocells, microcells, picocells, and femtocells. Additionally, in accordance with features of embodiments described herein, a small cell may be implemented as a standalone small cell, or a small cell (“SC”) or eNodeB (“eNB”), in which its functionality is contained within a single component, or it may be implemented as a split small cell in which its functionality is split into separate components including a central small cell (“cSC”) and a remote small cell (“rSC”).

In one embodiment of the architecture, a Hybrid Fiber Coax (HFC) plant infrastructure and/or 802.11ax (colloquially termed “Wi-Fi 6”) protocols are used as bases for provision of standards-compliant ultra-low latency and high data rate services (e.g., with capabilities associated with 3GPP 4G and 5G, and IEEE Std. 802.11 services based on 802.11ax technology). These services may include symmetric or asymmetric US and DS bandwidth which can be dynamically allocated, flexible scheduling of data (to e.g., prioritize real-time data over non-real-time data), and support of cellular, WLAN and PAN (e.g., IoT) services, all via a common service provider. The exemplary use of Wi-Fi 6 technology provides not only the capability for symmetric operation of downstream (DS) and upstream (US) transmissions but also a symmetric capacity, which may not be possible with e.g., use of an 802.11ac router backhauled by DOCSIS.

Further, various configurations and topologies, made available via the aforementioned technologies and the HFC plant infrastructure, are used for provision of various types standards-compliant ultra-low latency and high data rate services to user devices disposed at edge of a distribution network, as well as within different types of venues.

In one variant, an expanded frequency band (approximately 1.6-4 GHz in total bandwidth) is used over the coaxial portions of the HFC infrastructure. This expanded band is allocated to two or more primary data sub-bands, as well as to Industrial, Scientific and Medical (ISM) and cellular uses. Wideband amplifier apparatus are used to support DS and US utilization of the sub-bands within the network, including by premises devices via re-use of coaxial infrastructure. This allows the entity that installed such coaxial infrastructure to maintain its footprint in its customer's premises and continue to provide additional services without laying any significant amounts of optical fiber or other such alternate solutions.

In another variant, the foregoing expanded frequency band is divided among and used by two (or more) sub-nodes to provide data services that are better suited to different types of user premises or use cases. Additionally, the division of the expanded frequency band allows the sub-nodes to carry less capabilities/components so as to allow e.g., lower per-unit cost.

In yet another variant, the use of 802.11ax APs for delivery of ultra-high data rate services allow e.g., 4.8 Gbps data rate services, which can allow for example two (2) users to take advantage of 2.4 Gbps data rate in parallel (instead of allowing one (1) user to get all of 4.8 Gbps due to silicon limitation). In another variant, a plurality of access and modulation scheme, such as an OFDM and TDD/FDD/LBT-based scheme is used to allow for maximal efficiency and flexibility in allocating bandwidth to downstream and upstream transmissions over the HFC infrastructure.

Moreover, latency within the disclosed infrastructure is reduced by, inter alia, obviating encapsulation and other network/transport protocols normally necessitated through use of e.g., DOCSIS bearers and equipment (i.e., DOCSIS modems and cable-modem termination system (CMTS) apparatus within the MSO core).

### DETAILED DESCRIPTION OF EXEMPLARY EMBODIMENTS

Exemplary embodiments of the apparatus and methods of the present disclosure are now described in detail. While these exemplary embodiments are described in the context of the previously mentioned HFC cable system adapted for use with 5G and 3GPP technology, and network nodes, taps and CPE associated with or supported at least in part by a managed network of a service provider (e.g., MSO), other types of radio access technologies (“RATs”), and other types of networks and architectures that are configured to deliver digital data (e.g., text, images, games, software applications, video and/or audio) may be used consistent with the present disclosure. Such other networks or architectures may be broadband, narrowband, or otherwise, the following therefore being merely exemplary in nature.

It will also be appreciated that while described generally in the context of a network providing service to a customer or consumer or end user or subscriber (i.e., within a prescribed service area, venue, or other type of premises), the present disclosure may be readily adapted to other types of environments including, e.g., commercial/retail, or enterprise domain (e.g., businesses), or even governmental uses.

Additionally, while described primarily with reference to exemplary architectures and components set forth in co-owned U.S. Pat. No. 11,843,474 filed Feb. 11, 2020 and entitled “APPARATUS AND METHODS FOR PROVIDING HIGH-CAPACITY DATA SERVICES OVER A CONTENT DELIVERY NETWORK,” incorporated herein by reference in its entirety, the methods and apparatus of the present disclosure are not so limited, and in fact may adapted for use with other architectures and components by one of ordinary skill when given the present disclosure.

Also, while certain aspects are described primarily in the context of the well-known Internet Protocol (described in, inter alia, Internet Protocol DARPA Internet Program Protocol Specification, IETF RCF 791 (September 1981) and Deering et al., Internet Protocol, Version 6 (IPv6) Specification, IETF RFC 2460 (December 1998), each of which is incorporated herein by reference in its entirety), it will be appreciated that the present disclosure may utilize other types of protocols (and in fact bearer networks to include other internets and intranets) to implement the described functionality.

Other features and advantages of the present disclosure will immediately be recognized by persons of ordinary skill in the art with reference to the attached drawings and detailed description of exemplary embodiments as given below.

### Exemplary Network Architecture

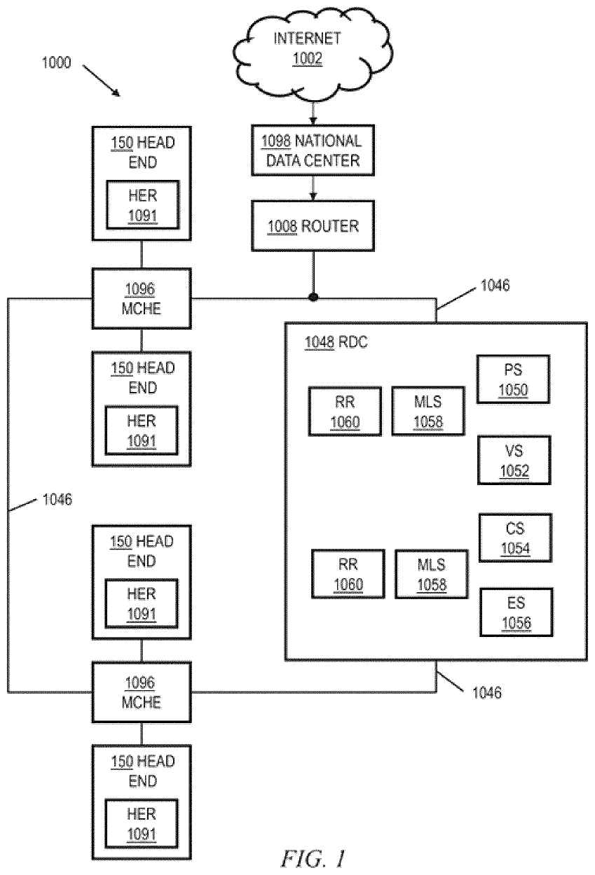

By way of example and not limitation, some embodiments will be shown in the context of a cable multi-service operator (MSO) providing data services as well as entertainment services. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter. RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

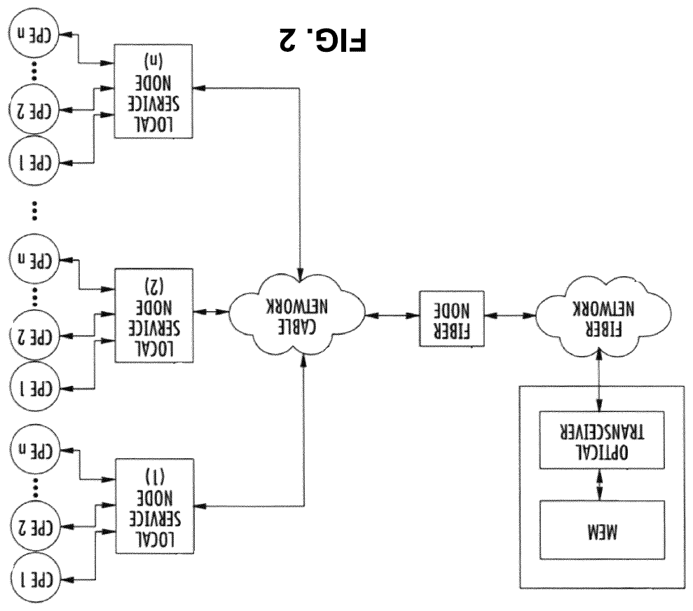

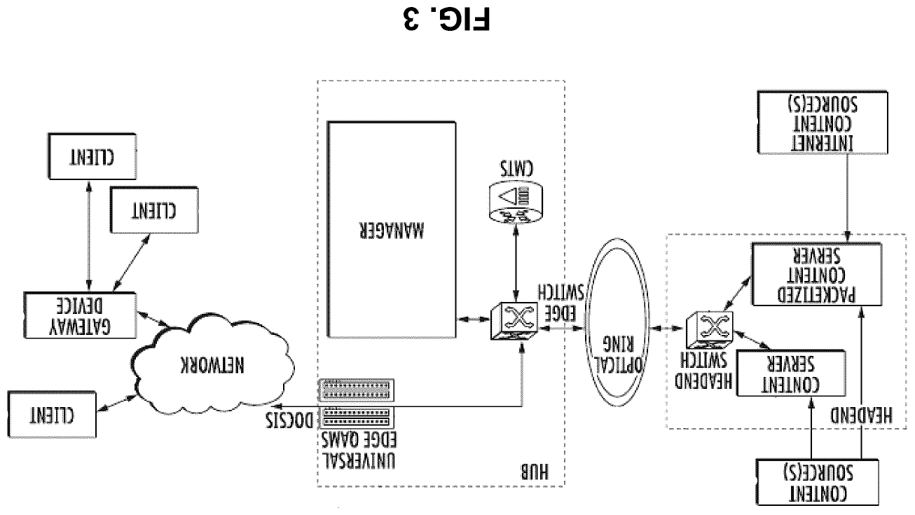

Under existing paradigms, network operators deliver data services (e.g., broadband) and video products to customers using a variety of different devices, thereby enabling their users or subscribers to access data/content in a number of different contexts, both fixed (e.g., at their residence) and mobile (such as while traveling or away from home). FIG. 2 and FIG. 3 are functional block diagrams illustrating a typical prior art managed (e.g., HFC) content delivery network architecture used to provide such data services.

In such networks, data/content delivery may be specific to the network operator, such as where content is ingested by the network operator or its proxy, and delivered to the network users or subscribers as a product or service of the network operator. For instance, a cable multiple systems operator (MSO) may ingest content from multiple different sources as shown in FIG. 1 (e.g., national networks, content aggregators, etc.), process the ingested content, and deliver it to the MSO subscribers via their hybrid fiber coax (HFC) cable/fiber network, such as to the subscriber's set-top box or DOCSIS cable modem.

Within the cable plant, VOD and so-called switched digital video (SDV) may also be used to provide content, and via utilization of a single-program transport stream (SPTS) delivery modality. In U.S. cable systems for example, downstream RF channels used for transmission of television programs are 6 MHz wide, and occupy a multitude of 6-MHz spectral slots between 54 MHz and 860 MHz. Upstream and “out of band” communications are normally relegated to the lower end of the available spectrum, such as between 5 and 85 MHz. Deployments of VOD services have to share this spectrum with already established analog and digital services such as those described herein. Within a given cable plant, all homes that are electrically connected to the same cable feed running through a neighborhood will receive the same downstream signal. For the purpose of managing e.g., VOD services, these homes are grouped into logical groups typically called Service Groups. Homes belonging to the same Service Group receive their VOD service on the same set of RF channels.

Existing cable systems utilize what in effect amounts to a Frequency-Division Multiplexing (FDM) system with 6 MHz channels and roughly 700 MHz of available bandwidth capacity in total, each of the channels being QAM modulated and delivered to the end user via e.g., a tree-and-branch type of topology, with user's CPE (e.g., digital settop boxes, DOCSIS modems, and gateways) utilizing RF tuners to tune to the appropriate DS channels to receive their respective data or program streams. As previously noted, this approach has limitations on its capacity, and hence can only be expanded so far in terms of available bandwidth (both DS and US), and serving additional customers with additional services.

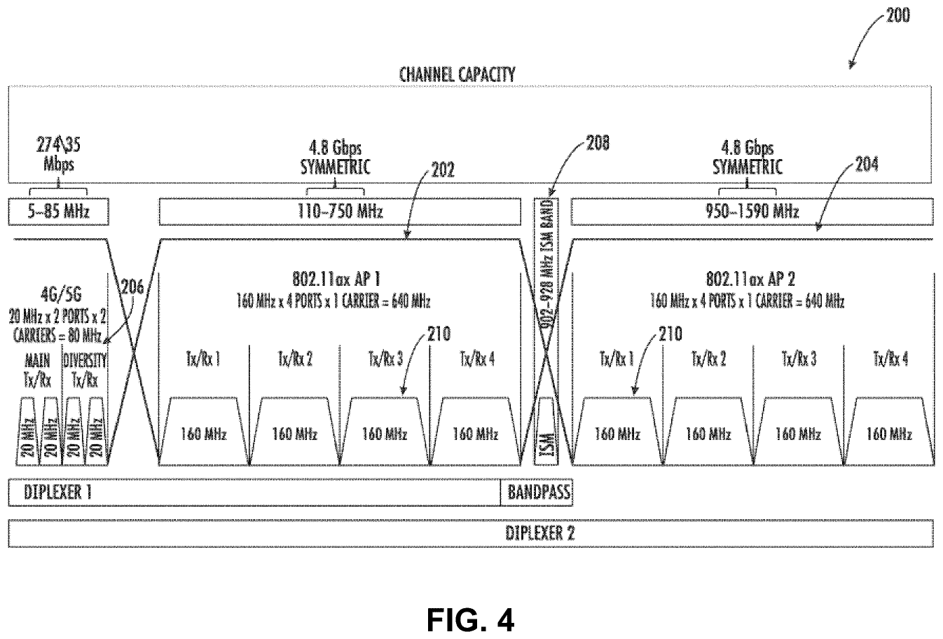

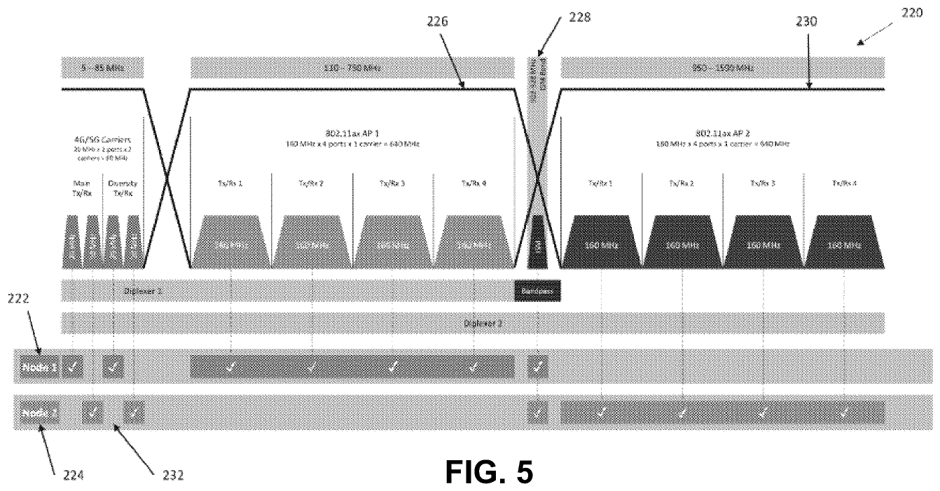

Accordingly, a new model is needed. As shown in the exemplary frequency plan 200 of FIG. 4, various embodiments of the present disclosure utilize two bands 202, 204 each comprised of four (4) 160-MHz-wide channels 210, the two bands as supported by each of two (2) 802.11ax-based APs (see discussion of FIGS. 4-5 infra), can each provide a symmetric data service at the rate of 4.8 Gbps. Due to extant silicon limitations in current 802.11ax chipsets as of the date of this disclosure, the entirety of the 4.8 Gbps bandwidth cannot be allocate to a single user; however, such capability is incipient, and the present disclosure explicitly contemplates such configurations. However, even under the existing silicon, two (2) users can each utilize up to 2.4 Gbps in parallel. Therefore, the two (2) 802.11ax APs can provide a very high data rate service by utilizing the two sets of four (4) 160-MHz channels.

Moreover, the frequency use plan 200 of FIG. 4 includes provision for other functions (in addition to symmetric or asymmetric primary band uses), including support of cellular waveforms provided via 5-85 MHz band 206 (which as noted previously is generally used for upstream data communication for DOCSIS or OOB communication in traditional cable systems), as well as data communication via one or more ISM bands 208 (e.g., at 902-928 MHz).

As will be described in greater detail below, the cellular band(s) 206 can support transmission of e.g., 3GPP 4G/4.5G/5G waveforms, over HFC, to and from the customer's premises, in effect making the MSO's system a huge DAS (distributed antenna system) for a cellular operator or MNO, or even the MSO itself when acting as a wireless service provider. For instance, in one such model, the MSO may use 3GPP-based technology as an underpinning for providing unlicensed or quasi-licensed service via e.g., NR-U bands, CBRS bands, C-Band, or even mmWave bands to its users or subscribers.

Similarly, the ISM band(s) 210 within the frequency plan 200 provide a number of different functions to aid in, among other things, CPE control and fault detection by the MSO.

As shown in FIG. 4, the overall spectrum utilized by the plan 200 is on the order of 1.6 GHz, roughly twice that of a typical MSO cable band under the prior art. Notably, the portions of the extant HFC architecture leveraged as part of the architectures of the present disclosure are not inherently limited by their medium and architecture (i.e., optical fiber transport ring, with coaxial cable toward the edges); coaxial cable can operate at frequencies significantly higher than the sub-1 GHz typically used in cable systems, and such additional bandwidth is made use of in the exemplary embodiments described herein.

Further, the foregoing spectrum of e.g., 1.6 GHz in bandwidth can be divided between multiple (e.g., two (2)) sub-nodes to allow, inter alia, a spectrum use plan that can be advantageous in providing data services that are more tailored to user premises and/or applications being served. For example, as shown in the embodiment of FIG. 2A, the plan 220 allocates approximately 700 MHz of bandwidth to one sub-node (Node 1) 222 while allocating another approximately 700 MHz of bandwidth to another sub-node (Node 2) 224. The division can be used for a multitude of purposes, including e.g., providing high-capacity data services to different parts of one or more user premises, via two or more nodes providing different paths (including combining or alternating such paths to provide e.g., additional reliability through redundancy), as discussed in more detail elsewhere herein.

As can be seen in FIG. 5, one sub-node 222 can be allocated e.g., 640 MHz of bandwidth 226 that can be serviced by one (1) 802.11ax AP, while another sub-node 224 can be allocated another 640 MHz of bandwidth 230.

As discussed further herein, each node can generate and/or provide its own data to be transmitted via ISM band 228, which is a shared-use channel. Accordingly, each sub-node 222, 224 can utilize the ISM band 228 as shown in FIG. 5, to e.g., send control data. Furthermore, the cellular band(s) 232, as introduced with respect to FIG. 4 above, can also be divided between the two sub-nodes 222, 224 as needed by e.g., utilizing one or more carrier signals or bands for each sub-node 222, 224 (e.g., in 20 MHz wide slices) as shown in FIG. 5.

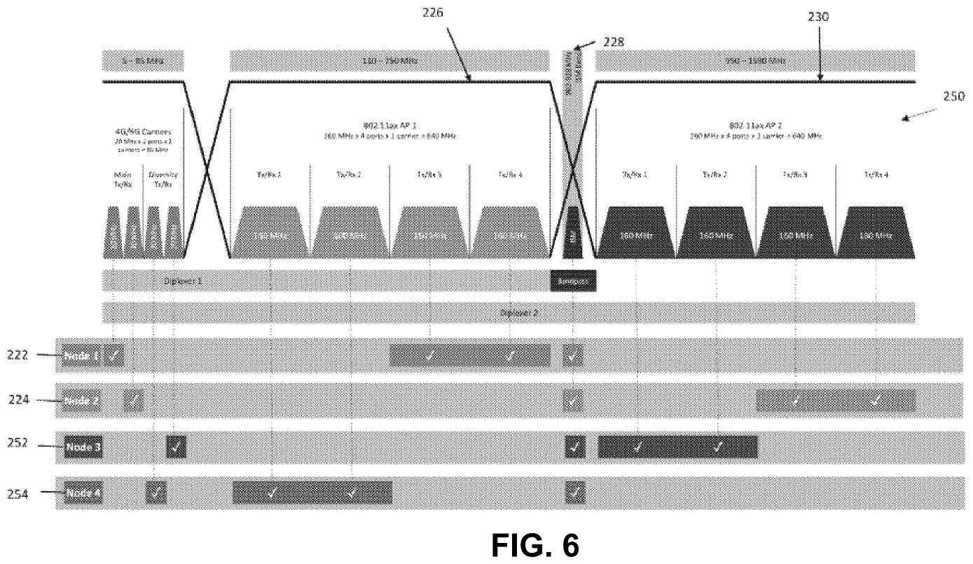

FIG. 6 illustrates yet another embodiment of a frequency plan 250 according to the present disclosure. In this plan, there are four (4) nodes 222, 224, 252, 254 which are each allocated a cellular band, two sub-band portions (of the four total comprising the bandwidth 226, 230), and use a common ISM band 228.

It will also be appreciated that the attenuation associated with any coaxial cable infrastructure is a function of, inter alia, coaxial conductor length, and hence higher levels of “per-MHz” attenuation may be acceptable for shorter runs of cable. Stated differently, nodes servicing (or serviced by) shorter runs of cable may be able to better utilize the higher-end portions of the RF spectrum (e.g., on the high end of the aforementioned exemplary 1.6 GHz band) as compared to those more distant, the latter requiring greater or disproportionate amplification. As such, the present disclosure also contemplates embodiments which make use of selective mapping of frequency spectrum usage as a function of total cable medium run length or similar.

### Exemplary Network Architecture (700)

Generally speaking, the various embodiments find utility within the context of any bandwidth distributing/sharing device requiring a BWP assignment from a network node (e.g., base station, eNB/gNB) connected thereto where the device capability does not necessarily reflect the actual bandwidth consumption of the device itself or other devices/services supported by the device. The various embodiments described herein provide a BWP update process that is triggered for each CPE associated with a network node (e.g., base station, eNB/gNB, small cell repeater) such that each CPE is generally allocated bandwidth as needed for a current mix of, illustratively, wireless access point (WAP) connected access terminals (ATs) and the liked so that, illustratively, a total spectrum allocated to a CBSD network node may be used as efficiently as possible.

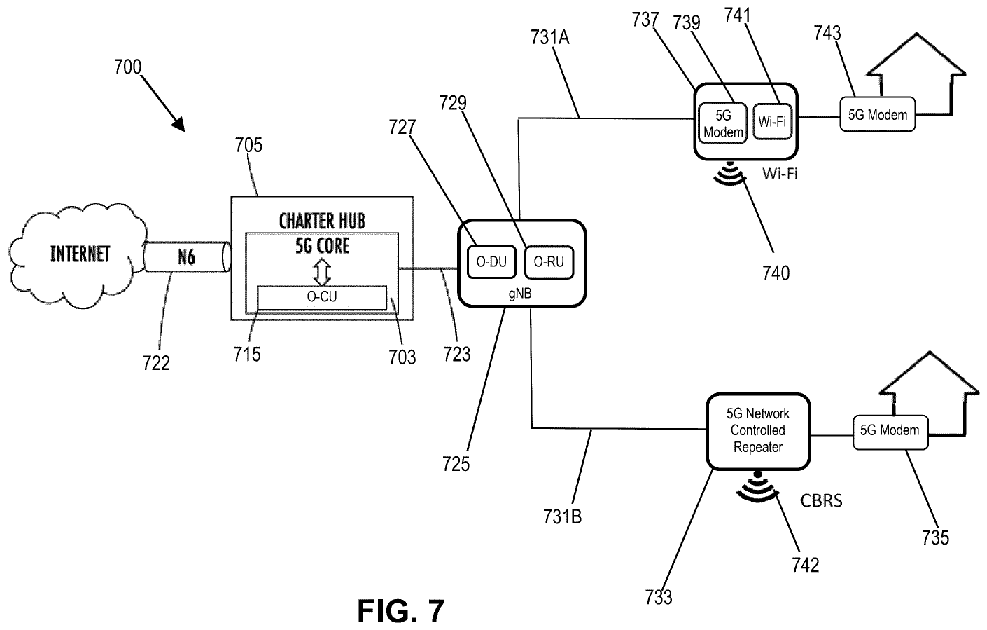

FIG. 7 depicts a block diagram of a network architecture benefitting from the various embodiments. The network architecture 700 of FIG. 7 is depicted as, illustratively, a data center, or hub 705 connected to the Internet over the extant N6 interface 722. The hub includes a 5G New Radio (NR) Core 703 that is configured to communicate with an open-control unit (O-CU) 715. The hub 705 can include a WLAN controller process, and services one or more nodes, with one node shown as a gNB node 725 in FIG. 7.

The hub 705 is configured to transmit a suitable signal to a node 725 via any suitable strand, such as cable 723. Cable 723 is any suitable optical fiber and/or coaxial cable.

The node 725 is any suitable node, such as an “enhanced” NR-based gNB architecture, which can be configured to utilize existing infrastructure (e.g., at least a portion of the extant HFC cabling controlled by an MSO such as the Assignee hereof) while expanding the frequency spectrum used for signal propagation within the infrastructure (e.g., greater than 1.6 GHz in total bandwidth). Moreover, access points or nodes installed at venues or premises, including “edge”-based nodes (at least some of which may be controlled, licensed, installed, or leased by the MSO), may be leveraged to deliver 5G-based services to a subscriber of the 5G NR Core 703. Such networking made possible through this leveraged infrastructure allows a subscriber to access receive and maintain 5G service whether indoor or outdoor, and in fact, even while the subscriber is changing locations, e.g., moving indoor to outdoor, outdoor to indoor, between servicing nodes indoors (e.g., within a large house, office or housing complex, or venue), and between servicing nodes outdoors.

The hub 705 comprises both the 5G NR core 703 and the O-CU 715, which may be an enhanced CU (CUe). The hub 705 includes these components logically (but not necessarily physically) and is in communication with the open distributed unit (O-DU) 727 of node 725 to relay data and content. The O-DU 727 can also be combined or integrated to varying degrees as well, with each node 725 both an O-DU 727 and an open radio unit “O-RU” 729 logically and/or physically within the node 725.

The node 725 is configured to transmit a signal over a coaxial cable 731A to a CPE 737 that is connected to an outdoor antenna 740 (or more than one outdoor antenna), the outdoor antenna 740 configured to transmit a Wi-Fi signal outdoors.

The CPE 737 can be a CPE capable of receiving radio frequency waveforms from network node 725 and O-RU 729 via the coaxial cable 731A, in a coaxial cable network or a hybrid fiber/coaxial network (HFC). As used herein, CPE refers without limitation to any type of electronic equipment located within a customer's or subscriber's premises and connected to or in communication with the network 700. Thus, CPE 737 can include any equipment in the “customers' premises” (or other appropriate locations) that can be accessed by the relevant upstream network components, such as O-RU 729 via the coaxial cable 731A. Non-limiting examples of CPE are television (TV) sets/Smart TV's, set-top boxes, modems, personal video recorders (e.g. digital video recorder (DVR)), gateways, modems, personal computers (PCs), and minicomputers, whether desktop, laptop, or otherwise, and mobile devices such as handheld computers, PDAs, personal media devices (PMDs), tablets, “phablets”, smartphones, vehicle infotainment systems, and Advanced Wireless Gateways (AWGs) for providing high bandwidth Internet access in premises such as homes and businesses, or any portion and/or combination thereof.

The CPE 737 can include a 5G modem 739 in communication with a Wi-Fi transceiver 741. The 5G modem 739 can receive a suitable signal via coaxial cable 731A and then transmit a signal in any suitable way, such as via an ethernet cable and/or wireless to various user equipment via the suitable Wi-Fi transceiver 741. The signal received via the coaxial cable 731A, transmitted from node 725, is a signal spanning an expanded frequency spectrum to cover 2 GHz plus, or 2400 MHz plus, bandwidth needs, or up to sixteen layers for 200 MHz wide channels to create up to the 2 GHz plus, or 2400 MHz plus, wide bandwidth. The CPE 737 is configured to receive this expanded frequency spectrum and transmit all or a portion of the bandwidth outdoors via outdoor antenna 740.

CPE 737 can also be configured to transmit all or a portion of the signal received via coaxial cable 731A to 5G modem 743, within an interior of a customer's premises, for suitable use within the customer premises.

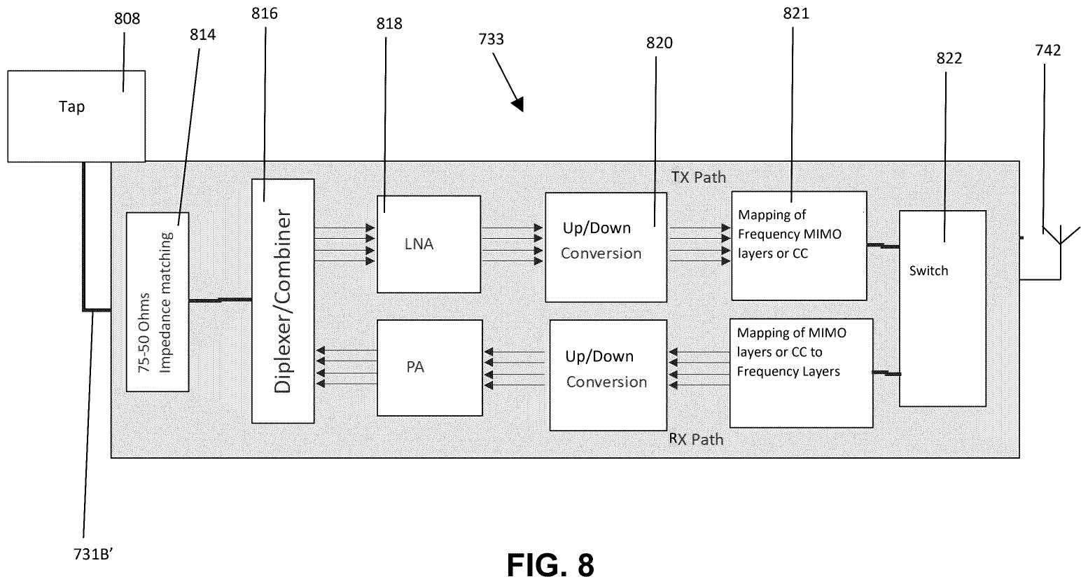

The node 725 is configured to transmit a signal over a coaxial cable 731B to a 5G Network Controlled Repeater “small cell” 733. Although only one small cell is shown in FIG. 7, in other embodiments, two or more similar small cells can be connected to node 725 via various coaxial cables. The small cell 733 can be any external radio access node e.g., 3GPP “femtocell”), including a pole-mounted 5G-enabled remote radio head (RRH) with an associated Evolved Universal Terrestrial Radio Access Network (E-UTRAN) node. Small cell 733 can leverage e.g., 3GPP unlicensed bands (such as NR-U bands in the 5 GHz range) or other spectrum such as CBRS (3.550-3.70 GHz, 3GPP Band 48), and C-Bands (3.30-5.00 GHZ). Technologies for use of other bands such as 6 GHz band (5.925-7.125 GHz such as for Wi-Fi-6), and even mmWave bands (e.g., 24 GHz and above). The small cell 733 is discussed in more detail in reference to FIG. 8 herein.

The small cell 733 is located in a backhaul portion of the network, and in this exemplary scenario, the backhaul is serviced by extant HFC infrastructure such as coaxial cable 731B. The small cell 733 is in data communication with both the O-RU 729 and the O-DU 727.

The signal received by the small cell 733 via the coaxial cable 731B, transmitted from node 725, is a signal spanning an expanded frequency spectrum to cover 2 GHz plus, or 2400 MHz plus, bandwidth needs, or up to sixteen layers for 200 MHz wide channels to create up to the 2 GHz plus, or 2400 MHz plus, wide bandwidth. The small cell 733 is configured to receive this expanded frequency spectrum and transmit all or a portion of the bandwidth outdoors via antenna 742. Although not shown in FIG. 7, one or more taps can be present on coaxial cable 731B, between the node 725 and the small cell 733.

Antenna 742 is configured to transmit a 5G signal over the CBRS spectrum.

Small Cell 733 can also be configured to transmit all or a portion of the signal received via coaxial cable 731B to 5G modem 735, within an interior of a customer's premises, for suitable use within the customer premises.

One advantage of the network architecture 700 is that only one O-RU 729 is present in the network architecture 700, which is configured to transmit a signal to one or more small cells (such as small cell 733) so that each small cell 733 does not include a respective radio unit. Thus, architecture 700 as well as other architecture disclosed herein can include one, single O-RU-729 to transmit signals to two or more small cells 733.

Various elements or portions thereof depicted in FIG. 7 and having functions described herein are implemented at least in part as computing devices having communications capabilities, including for example the node 725, the O-DU 727, the O-RU 729, the small cell 733 and the CPE 737, and various network nodes and network functions of the hub 705. These elements or portions thereof have computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using network equipment used to implement network functions at a network core, network equipment comprising processing resources (e.g., one or more servers, processors and/or virtualized processing elements or compute resources) and non-transitory memory resources (e.g., one or more storage devices, memories and/or virtualized memory elements or storage resources), wherein the processing resources are configured to execute software instructions stored in the non-transitory memory resources to implement thereby the various methods and processes described herein. The network equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

### Exemplary Small Cell (706-1 of FIG. 7)

According to any of the embodiments herein, the small cell 733 can have a structure shown in FIG. 8, and can receive a signal via one or more optional taps 808. As seen in FIG. 8, the small cell 733 receives a signal via a coaxial cable 731B′, with coaxial cable 731B′ extending from the tap 808 to the small cell 733.

Tap 808 can be any suitable tap, such as a 2-way, 4-way or 8-way tap. The signal transmitted through the tap 808, via the coaxial cable 731B′ is received by the small cell 733. The incoming signal over the coaxial cable 731B′ enters the small cell 733 and undergoes impedance matching for loads in the 50-752 range in an impedance matching component 814. The incoming signal over the coaxial cable 731B′ is transmitted from the O-RU 729 (shown in FIG. 7). The O-RU 729 can either transmit wider bandwidths to the small cell 733 to cover 2 GHz plus bandwidth needs, or send up to sixteen layers for 200 MHz wide channels to create up to the 2 GHz plus wide bandwidth from the O-RU 729.

After the signal exits impedance matching component 814, along the receiving (RX) path of the small cell 733 the signal is separated by diplexer and/or combiner device 816, with the separated signal then being amplified in a low noise amplifier 818. After the signal is amplified by low noise amplifier and then passing through a suitable signal converter 820. The signal converter 820 is any suitable conversion element that is configured to increase and/or decrease the separated signal at the signal converter 820 to an emission signal at the emission frequency needed to be radiated by the antenna 742.

After the emission signal is converted to the frequency to be transmitted via antenna 742, that converted frequency is mapped to two or more multiple-input multiple-output (MIMO) layers or multiple component carriers (CC) by a suitable transceiver node 821 and are then transmitted from the small cell 733 via the antenna 742. The transceiver node 821 is configured to map the converted frequencies to one or more MIMO layers (or CC) to converge at a destination, e.g. CPE or User Equipment (UE). In one embodiment, the two or more MIMO layers (or CC) are mapped to the frequency resources by the transceiver node 821 based at least on channel quality feedback from the destination back to the small cell 733. In another embodiment, the mapping can include the transceiver node 821 selecting an appropriate modulation and coding scheme (MCS) for each of the MIMO layers.

Prior to transmission from the antenna 742 of the signals mapped in the transceiver node 821, the signals are transmitted through a switch 822. Switch 822 can be any suitable switch apparatus, such as a di-pole di-throw (DPDT) switch that is configured to activate a path to provide a feedback signal from the antenna 742 through the receiving (Rx) path and to activate a path to provide a transmission signal from the transceiver node 821 to the antenna 742.

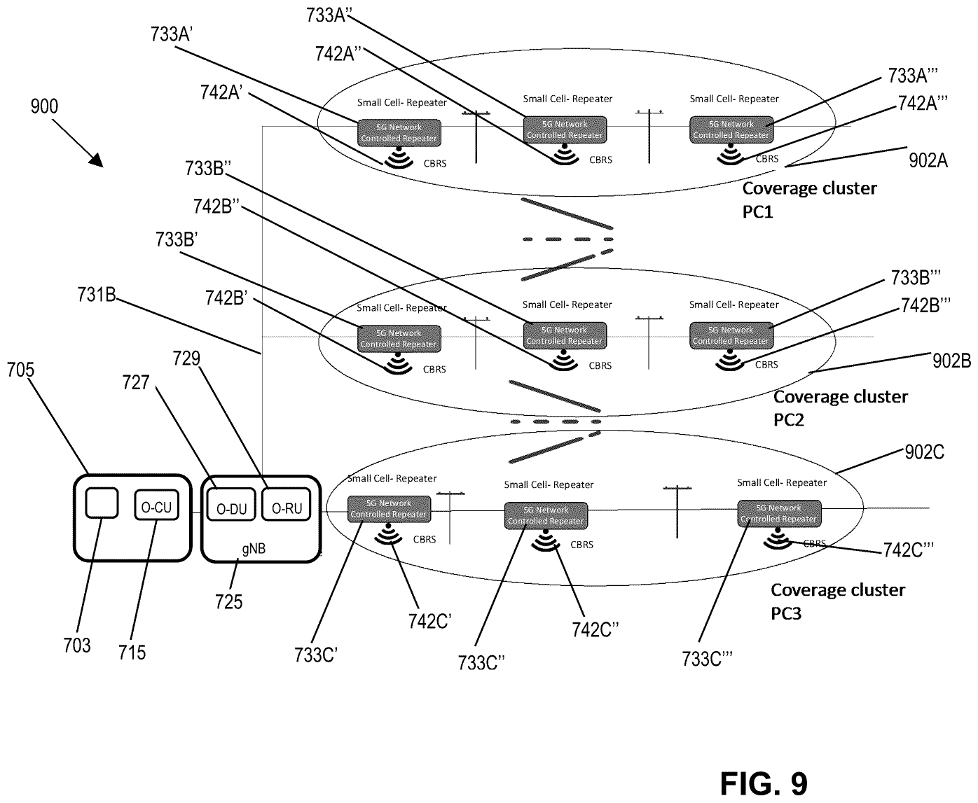

FIG. 9 depicts another embodiment, which is a block diagram of a network architecture 900 for a plurality of small cell repeaters 733. One small cell repeater 733, and its respective antenna 742, is shown in FIG. 7. Although not shown in FIG. 9, the architecture 900, one or more taps 808 can be included at one or more locations throughout the architecture 900.

The network architecture 900 can include a plurality of small cell repeaters 733A′-733C′″, and their respective antennas 742A′-742C′″, each receiving signals from one node 725 and one radio unit O-RU 729. Each of the plurality of small cell repeaters 733 receives their respective signals from the one radio unit O-RU 729 via coaxial cable 731B, and then via other coaxial cables throughout the architecture 900.

The plurality of small cell repeaters 733 can be grouped into coverage clusters 902A-902C. For example, small cell repeaters 733A′, 733A″, and 733A′″ are all within coverage cluster 902A. Each coverage cluster can support the same physical call identification (PCI) for each repeater within the coverage cluster. For example, the small cell repeaters 733A′, 733A″, and 733A′″ of coverage cluster 902A can all be operating under the same PCI (“PC1” of FIG. 9) for user equipment (UE) within the respective cluster. Thus, no mobility is needed for the UE within each respective coverage cluster 902A-902C, with each UE sharing the same capacity within the respective coverage cluster 902A-902C. In the architecture 900, capacity can be managed by dividing one or more of the coverage clusters 902A-902C to create an additional cluster with a different PCI, as needed or desired.

Since each respective cluster 902A-902C has their own same or differing capacities, mobility between each respective coverage cluster 902A-902C can be managed by handovers, which are managed at the node 725.

Although three coverage clusters are shown in FIG. 9, in other embodiments, one, two four or more coverage clusters can be included in architecture 900, with each cluster having the same or different number of small cell repeaters 733. Additionally, even though each coverage cluster 902A-902C of architecture 900 includes three small cell repeaters 733, in other embodiments each coverage cluster 902A-902C can have the same or different number of small cell repeaters 733, and can be one, two, four or more small cell repeaters. In the embodiment shown in FIG. 9, the coverage clusters 902A-902C do not overlap eachother, however, in other embodiments, the coverage clusters 902A-902C can contact and/or overlap adjacent coverage clusters.

Each of the coverage clusters 902A-902C of architecture 900 are areas of emission of RF signals from the antenna within each respective cluster. Although the emission clusters 902A-902C are illustrated as being an oval shape in architecture 900, the shape of each emission cluster can be any shape and can be influenced by topography, structures, trees, etc., and each cluster can span indoor space and/or outdoor space. Each of the plurality of small cell repeaters 733 in each respective coverage cluster 902A-902C is in relatively close proximity to create each respective coverage cluster 902A-902C.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

1. A small cell apparatus comprising:
a port to interface with a coaxial cable, the coaxial cable configured to transmit a signal from a radio unit (RU);
an impedance matching component configured to sufficiently match the signal;
a diplexer configured to separate the signal into a separated signal;
a signal converter configured to increase and/or decrease the separated signal to an emission signal at an emission frequency;
a transceiver node configured to map the emission signal to two or more multiple-input multiple-output (MIMO) layers; and
an antenna configured to transmit the two or more MIMO layers.

2. The apparatus of claim 1, wherein the RU is a single RU.

3. The apparatus of claim 1, wherein the coaxial cable further comprises a tap.

4. The apparatus of claim 1, further comprising a low noise amplifier (LNA) configured to amplify the separated signal.

5. The apparatus of claim 1, further comprising a switch, wherein the switch is configured to activate a path to provide a feedback signal from the antenna through a receiving (Rx) path and to activate a path to provide a transmission signal from the transceiver node to the antenna.

6. The apparatus of claim 1, wherein the coaxial cable transmits up to a 2400 MHz wideband spectrum.

7. The apparatus of claim 1, wherein the impedance matching component comprises a matching for loads in a 50-7552 range.

8. The apparatus of claim 1, wherein the two or more MIMO layers are mapped based on a channel quality feedback from a destination back to the small cell apparatus.

9. A network architecture comprising:
two or more small cell apparatus of claim 1;
a single RU configured to transmit a signal over coaxial cable to the two or more small cell apparatus.

10. The network architecture of claim 9, wherein the two or more small cell apparatus comprise two or more coverage clusters.

11. The network architecture of claim 10, wherein the two or more coverage clusters each comprise two or more small cell apparatus.

12. The network architecture of claim 10, wherein each of the two or more coverage clusters comprises a physical call identification (PCI) that is different than a PCI of any of the other two or more coverage clusters.

13. A method of transmitting a signal, the method comprising:
receiving a signal from a coaxial cable at a port of a small cell apparatus from a radio unit (RU);
matching an impedance of the signal;
separating the signal into a separated signal;
increasing and/or decreasing the separated signal to an emission signal at an emission frequency;
mapping the emission signal to two or more multiple-input multiple-output (MIMO) layers; and
transmitting the two or more MIMO layers from an antenna.

14. The method of claim 13, wherein the RU is a single RU.

15. The method of claim 13, wherein the coaxial cable further comprises a tap.

16. The method of claim 13, further comprising amplifying the separated signal via a low noise amplifier (LNA).

17. The method of claim 13, activating a path to provide a feedback signal from the antenna through a receiving (Rx) path or activating a path to provide a transmission signal from the antenna.

18. The method of claim 13, wherein the coaxial cable transmits up to a 2400 MHz wideband spectrum.

19. The method of claim 13, wherein the impedance matching comprises a matching for loads in a 50-7502 range.

20. The method of claim 13, wherein the two or more MIMO layers are mapped based on a channel quality feedback from a destination back to the small cell.
